(19) United States
(12) Patent Application Publication
(10) Pub. No.: US 2005/0067114 A1
(43) Pub. Date: Mar. 31, 2005

(54) Tire fitting method and device

(75) Inventor: Hideki Kusunoki, Nishikamo-gun (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/940,710

(22) Filed: Sep. 15, 2004

(30) Foreign Application Priority Data
Sep. 26, 2003 (JP) 2003-334525

(51) Int. Cl. B60C 1/00; B60C 25/00

(52) U.S. Cl. 157/1

(57) ABSTRACT

A wheel is positioned at an initial position by partially fitting a tire, from above, to the wheel in a slanting direction. From state where the wheel is positioned at the initial position, an expander, which expand paired bead portions of the tire in a radial direction of the wheel, is turned around the rotational axis of the wheel. In the initial position, the tire is positioned with respect to the wheel while an accessory does not overlap a lower portion of a lower bead portion that is provided at a lower position from among the paired bead portions in the initial position, the lower portion being provided below an upper rim flange portion that is provided at an upper position from among the paired rim flange portions, and the lower portion already being fitted to the wheel.

### INCORPORATION BY REFERENCE

The disclosure of Japanese Patent Application No. 2003-334525 filed on Sep. 26, 2003, including the specification, drawings and abstract thereof, is incorporated herein by reference in its entirety.

### BACKGROUND OF THE INVENTION

1. Field of the Invention

The invention relates to a method and a device for fitting a tire to a rim periphery of a wheel, to which an accessory is attached in advance. More particularly, the invention relates to a technology for preventing damage to the accessory caused by the tire fitting.

2. Description of the Related Art

Various methods for fitting a tire to a wheel are known. An example of such methods is disclosed in Japanese Patent Laid-Open Publication No. 01-153311. According to such a method, generally, a tire is partially fitted, from above, to a horizontally placed wheel in a slanting direction. Then, an expander for expanding the tire in a radial direction is turned around the axis of the wheel. As a result, the tire is entirely fitted to the wheel.

In recent years, information concerning a tire is obtained while a vehicle is running. Accordingly, a sensor as an accessory is attached to a wheel to which the tire is fitted. This type of sensor is used for detecting a tire inflation pressure, a temperature of the tire, distortion of the tire, forces applied to the tire in an up-and-down direction, a lateral direction, and a front-and-rear direction, and the like. Together with the sensor, a communication device as an accessory may be attached to the wheel. Also, a unit constituted by integrating a sensor with a communication device may be attached to the wheel.

The above-mentioned accessory is usually attached to the wheel before the tire is fitted to the wheel. Meanwhile, an accessory such as a sensor may be easily damaged due to an unexpected external force. Therefore, it is necessary to be careful not to apply an excessive external force, which is generated due to contact with the tire, to the accessory.

Accordingly, when the tire fitting method in the above-mentioned technology is performed, a careful operation is required so as not to cause damage to the accessory due to the tire fitting. Therefore, in order to reduce a load on a worker and to improve efficiency of the tire fitting operation, an appropriate tire fitting method has been desired.

The invention is made in the light of the above-mentioned circumstances. It is an object of the invention to easily prevent damage to an accessory caused by the tire fitting, in a method and device for fitting a tire to a rim periphery of a wheel to which the accessory is attached in advance.

### SUMMARY OF THE INVENTION

According to the invention, the following aspects can be realized. The aspects will be classified into sections, and a number is assigned to each of the sections. Descriptions will be made by citing a number of another section if necessary. The descriptions will be made in this manner in order to facilitate understanding of some or a combination of technical features according to the invention. Therefore, it should not be interpreted that the technical features or combinations thereof according to the invention are limited to the following aspects. Namely, it should be interpreted that it is possible to extract and employ, as appropriate, technical features which are not disclosed in the following aspects but which are disclosed in the specification.

In addition, disclosing each section by citing a number of another section does not necessarily signify that separating the technical features disclosed in the section from the technical features disclosed in the other section and making the technical features disclosed in the section independent is not possible. It should be interpreted that the technical features disclosed in each section can be made independent according to characteristics thereof as deemed appropriate.

(1) There is provided a tire fitting method or device which initially positions a wheel at an initial position by partially fitting a tire, from above, to the wheel with the rotational axis of the tire being inclined with respect to the rotational axis of the wheel, and which then turns an expander, from a state where the wheel is positioned at the initial position, around the rotational axis of the wheel, the expander partially contacting, from the side, a portion of paired bead portions of the tire, that are opposed to each other in an axial direction of the tire, the portion being to be fitted to a rim outer surface, and the expander expanding the paired bead portions in a radial direction of the wheel, in order to fit the tire to the rim outer surface, to which an accessory is attached in advance, in the wheel having a rim in which paired rim flange portions that are opposed to each other are formed. This tire fitting method or device includes a tire positioning process for positioning the tire with respect to the wheel, in a state where the accessory does not overlap a lower portion of a lower bead portion that is provided at a lower position from among the paired bead portions in the initial position, the lower portion being provided below an upper rim flange portion that is provided at an upper position from among the paired rim flange portions, and the lower portion already being fitted to the wheel, when the wheel and the tire are viewed from a direction perpendicular to a plane surface including the rotational axis of the wheel and the rotational axis of the tire in the initial position.

When this method or device is realized, in the initial position of the tire, if the wheel and the tire are viewed from the direction perpendicular to the plane surface including the rotational axis of the wheel and the rotational axis of the tire, which is inclined to the rotational axis of the wheel, the accessory attached to the rim outer surface in advance is distant, in the axial direction of the wheel, from the lower bead portion that is provided at the lower position from among the paired bead portions in the tire.

In addition, a portion of the lower bead portion, to which the accessory is opposed in the axial direction of the wheel (hereinafter, referred to as an “portion which is opposed to the accessory”) is included in the lower portion of the lower bead portion, which is positioned below the upper rim flange portion and which has already been fitted to the wheel in the initial position.

When the method or device according to this section is realized, the expander starts to be turned from the initial state, and then initially contacts an upper portion of the lower bead portion, which is positioned above the upper rim flange portion and which has not been fitted to the wheel in the initial position. The position of the expander when the expander starts to contact the upper portion is a contact start position.

In a contact position in the lower bead portion, at which the expander contacts the lower bead portion, the lower bead portion of the tire is expanded by the expander in the radial direction of the tire. As a result, a tension is generated in the lower bead portion in the circumferential direction thereof. In addition, in the contact position, a portion which is a diameter of the lower bead portion and which passes the contact position is expanded. As a result, a pressing force for pressing the lower bead portion to the rim outer surface of the wheel in the radial direction is generated.

When the expander is further turned from the contact start position, a region in the tire, which has been fitted to the wheel, increases as the turning angle increases. Meanwhile, a region in the tire, which has not been fitted to the wheel, decreases as the turning angle increases. Finally, the region in the tire, which has not been fitted to the wheel, disappears, and the entire lower bead portion is fitted to the wheel.

While the region in the tire, which has been fitted to the wheel, increases, each circumferential portion in the region is moved downward in the axial direction of the wheel between the paired rim flange portions in the wheel.

Accordingly, when the tire fitting method or device is realized, in an area in which the expander is turned from a turning start position to the above-mentioned contact start position, a tension as well as a pressing force is hardly generated in the portion of the lower bead portion, which is opposed to the accessory.

Meanwhile, in an area where the expander is further turned from the contact start position, a tension is generated in the lower bead portion. However, the portion of the lower bead portion 72, which is opposed to the accessory, has already been fitted to the wheel, and an opposite portion with respect to the center of the wheel 12 has also been fitted to the wheel 12 already. Therefore, a tension is generated in the portion of the lower bead portion, which is opposed to the accessory. However, a pressing force for pressing the lower bead portion to the accessory is hardly generated.

In the area where the expander is further turned from the contact start position, the portion of the lower bead portion, which is opposed to the accessory, is moved downward in the axial direction of the wheel, as the turning angle of the expander increases.

When the method or device according to this section is realized in the aspect where the tire is positioned with respect to the wheel such that the accessory is positioned above the lower bead portion in the initial position of the tire, in the area where the expander is further turned from the contact start position as well as in the preceding area, the lower bead portion does not contact the accessory.

In contrast to this, when the method or device according to the section is realized in the aspect where the tire is positioned with respect to the wheel such that the accessory is positioned below the lower bead portion in the initial position of the tire, in the area where the expander is further turned from the contact start position, the portion of the lower bead portion, which is opposed to the accessory, may contact the accessory when being moved downward, unlike in the preceding area.

However, even if the lower bead portion partially contacts the accessory, the portion of the lower bead portion, which is opposed to the accessory, has already been fitted to the wheel before contacting the accessory, and is not expanded in the radial direction. Accordingly, the lower bead portion does not strongly press the accessory when contacting the accessory.

Therefore, with the method or device according to this section, as long as the tire is positioned with respect to the wheel while the accessory does not overlap the lower portion of the lower bead portion, which has already been fitted to the wheel, in the initial position of the tire, it is possible to prevent damage to the accessory caused by tire fitting, regardless of whether the tire is positioned with respect to the wheel such that the accessory is positioned above the lower bead portion or such that the accessory is positioned below the lower bead portion.

As is clear from the above description, with the method or device according to this section, it becomes easier to reduce a load on a worker for preventing damage to the accessory caused by tire fitting and to improve efficiency of the tire fitting operation.

The “accessory” in this section may be configured to include at least one electric component or electronic component, such as a sensor or a communication device for communicating with the outside.

Also, the “accessory” in this section may be configured to include a sensor which detects a state quantity of a tire/wheel assembly constituted by fitting the tire to the wheel. Examples of such a sensor are a sensor for detecting a tire inflation pressure, a sensor for detecting a temperature of the tire, a sensor for detecting distortion of the tire, and a sensor for detecting forces applied to the tire in an up-and-down direction, a lateral direction, and a front-and-rear direction.

(2) There is provided the tire fitting method or device according to section (1), wherein the accessory is opposed to the lower portion in the axial direction of the wheel in the initial position.

(3) There is provided the tire fitting method or device according to section (1) or (2), wherein the tire is positioned with respect to the wheel such that the accessory is positioned below the lower portion in the initial position, in the tire positioning process.

With the method or device, when the expander is being turned, in the area where the expander is further turned from the contact start position, the portion of the lower bead portion, which is opposed to the accessory, may contact the accessory while being moved downward, unlike the preceding area.

However, even if the lower bead portion partially contacts the accessory, the portion of the lower bead portion, which is opposed to the accessory, has already been fitted to the wheel before contacting the accessory, and is not expanded in the radial direction. Accordingly, the lower bead portion does not strongly press the accessory when contacting the accessory.

(4) There is provided the tire fitting method or device according to any one of sections (1) to (3), further including a lower bead portion fitting process in which the lower bead portion is fitted to the wheel by turning the expander one-half turn around the rotational axis of the wheel in the forward direction from the start position to the reverse position while the expander partially contacts the lower bead portion from the side; and an upper bead portion fitting process, in which the upper bead portion is fitted to the wheel by turning the expander one-half turn around the rotational axis of the wheel in the backward direction from the reverse position to the start position while the expander partially contacts the upper bead portion from the side, after the entire lower bead portion is fitted to the wheel.

With the method or device, the lower bead portion is fitted to the wheel by turning the expander in the forward direction, and the upper bead portion is fitted to the wheel by turning this expander in the backward direction.

(5) There is provided the tire fitting method or device according to section (4) further including a wheel positioning process in which the wheel is positioned such that the accessory is positioned at a circumferential position which is different from two positions corresponding to the start position and the reverse position, respectively, from among circumferential positions of the wheel before the tire positioning process is performed.

When the tire is in the initial position, the lower bead portion has already been fitted to the wheel at the position corresponding to the start position of the expander from among the circumferential positions of the wheel. In contrast to this, at the position opposite to the start position with respect to the center of the wheel, that is, the position corresponding to the reverse position of the expander, the lower bead portion has not been fitted to the wheel.

Accordingly, when the expander is at the reverse position, and the lower bead portion is attempted to be fitted to the wheel at the reverse position, the lower bead portion is expanded in the radial direction. As a result, a force for pressing the lower bead portion to the wheel in the radial direction is generated. This pressing force is a force for pressing the lower bead portion to the wheel at each of the start position and the reverse position.

At this time, a tension in the circumferential direction is generated, but the pressing force is hardly generated at the position whose phase is deviated from the start position and the reverse position by 90 degrees, that is, the position corresponding to the center position in the longitudinal direction of the wheel when the wheel and the tire are viewed from the direction perpendicular to the plane surface including the rotational axis of the wheel and the rotational axis of the tire.

Based on the above-mentioned findings, in the method or device according to this section, the wheel is positioned such that the accessory is positioned a circumferential position which is different from the two positions corresponding to the start position and the reverse position, respectively, from among the circumferential positions of the wheel, before the tire is positioned.

Therefore, with the method or device, a force for pressing the lower bead portion to the accessory, which is generated when the lower bead portion is attempted to be fitted to the wheel by the expander at the reverse position, is small, compared with the case where the wheel is positioned such that the accessory is at at least one of the two positions corresponding to the start position and the reverse position, respectively, from among the circumferential positions of the wheel.

(6) There is provided the tire fitting method or device according to section (4) or (5), wherein the lower bead portion fitting process is a process in which the expander and a presser device, that partially contacts an upper side surface provided at an upper position from among paired side surfaces of the tire and that presses the tire in the axial direction of the wheel, are turned one-half turn around the rotational axis of the wheel in the forward direction from the start position to the reverse position while the expander partially contacts the lower bead portion from the side; and the upper bead portion fitting process is a process in which the expander and the presser device are turned one-half turn around the rotational axis of the wheel in the backward direction from the reverse position to the start position while the expander partially contacts the upper bead portion from the side, after the entire lower bead portion is fitted to the wheel.

With the method or device, when the expander is being turned in the forward direction, fitting of the lower bead portion to the wheel is assisted by the presser device. In addition, when the expander is being turned in the backward direction, fitting of the upper bead portion to the wheel is assisted by the presser device.

(7) There is provided the tire fitting method or device according to section (6), further including a presser device position adjustment process in which a position of a portion of the presser device, which contacts the tire, is adjusted so as to be at a position which is deviated from an accessory pass plane where the portion passes the accessory in a direction perpendicular to the rotational axis of the wheel.

When the method or device according to section (6) is realized, the lower bead portion is initially fitted to the wheel by turning the expander and the presser device in the forward direction. Then, the upper bead portion is fitted to the wheel by turning the expander and the presser device in the backward direction.

When the expander and the presser device are being turned in the forward direction, the lower bead portion does not press the accessory strongly, since the portion of the lower bead portion, which is opposed to the accessory, has already been fitted to the wheel.

In contrast to this, when the expander and the presser device are being turned in the backward direction, the portion of the upper bead portion, which is opposed to the accessory, is originally positioned above the upper rim flange portion. Therefore, when the expander and the presser device pass the portion, the upper bead portion is expanded in the radial direction, crosses over the upper flange portion, and is fitted to the wheel. Therefore, the portion of the upper bead portion, which is opposed to the accessory, may press the sensor strongly.

However, when the tire fitting method or device is realized, the position of the presser device, which contacts the tire, is at a position which is deviated from the accessory pass plane in which the portion passes the accessory in a direction perpendicular to the rotational axis of the wheel.

Accordingly, when the presser device is turned in order to fit the upper bead portion to the wheel and the presser device passes the accessory during the turn, the upper bead portion 72 is prevented from strongly pressing the accessory by the presser roller 34.

(8) There is provided the tire fitting method or device according to section (7), in which the position of the portion of the presser device, which contacts the tire, is adjusted so as to be above the accessory pass plane, in the presser device position adjustment process.

The method or device according to section (7) can be realized in order to fit the tire to the wheel in which the accessory is attached to the rim at one end thereof, the accessory protruding from the rim outer surface.

When the accessory is provided in the wheel, a large bending moment relative to an applied force is generated at a free end, and a large bending moment is difficult to cause at a fixed end, from among the fixed end an the free end of the accessory.

Therefore, in order to prevent damage to the accessory caused by a pressing force (e.g., distortion due to bending) in the state where a pressing applied from the tire to the accessory cannot be prevented completely during tire fitting, it is desirable that the accessory be attached to the wheel such that the fixed end of the accessory is positioned near the upper rim flange portion which is provided at an upper position from among the paired rim flange portions and the free end of the accessory is positioned near the lower rim flange portion which is provided at a lower position from among the paired rim flange portions. The upper bead portion is normally fitted to the wheel so as to be fitted to the upper rim flange portion, and the upper bead portion may contact not the free end but the fixed end of the accessory.

In the case where the accessory is attached to the wheel in advance such that the fixed end of the accessory is positioned near the upper rim flange portion, and the free end of the accessory is positioned near the lower rim flange portion, when the method or device according to this section is realized, even when the upper bead portion is pressed to accessory by the presser device, the pressing is performed not at the free end but at the fixed end of the accessory. Accordingly, even the same pressing force is applied to the accessory, the bending moment generated in the accessory is small.

As a result, with the method or device, when the presser device is turned in order to fit the upper bead portion to the wheel, it is possible to prevent damage to the accessory, even when the upper bead portion contacts the accessory during the turn.

### BRIEF DESCRIPTION OF THE DRAWINGS

FIG. 1 is a side view showing a tire mounter 10 suitable for realizing a tire fitting method or device according to an embodiment of the invention;

FIG. 2 is a plan view showing a main portion of the tire mounter 10 in FIG. 1;

FIG. 3 is a partial cross sectional view showing a tire/wheel assembly 70 constituted by fitting a tire 16 to a wheel 12 in FIG. 1;

FIG. 4 is a flowchart showing an initial adjustment in the tire fitting method or device according to the embodiment;

FIG. 5 is a front view used for describing step S11 in FIG. 4; and

FIG. 6 is a flowchart showing a tire fitting routine in the tire fitting method or device according to the embodiment.

### DETAILED DESCRIPTION OF THE PREFERRED EMBODIMENTS

Hereafter, an embodiment of the invention will be described in detail with reference to accompanying drawings.

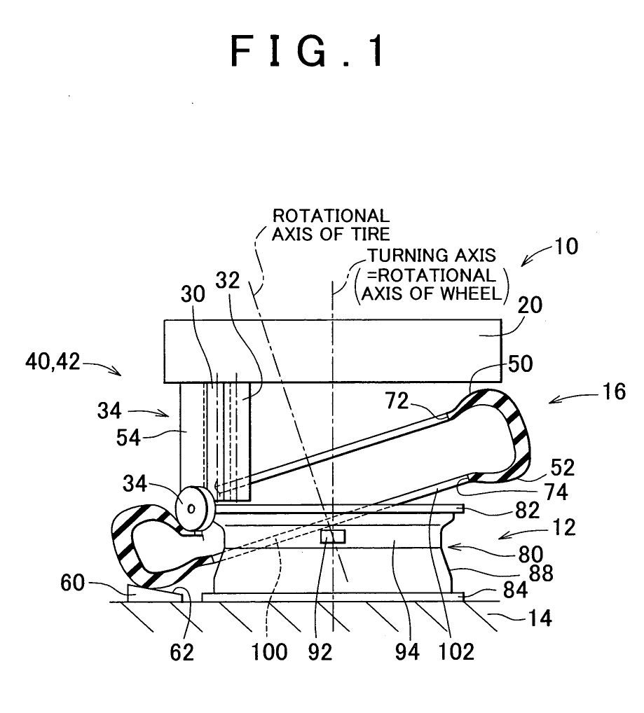

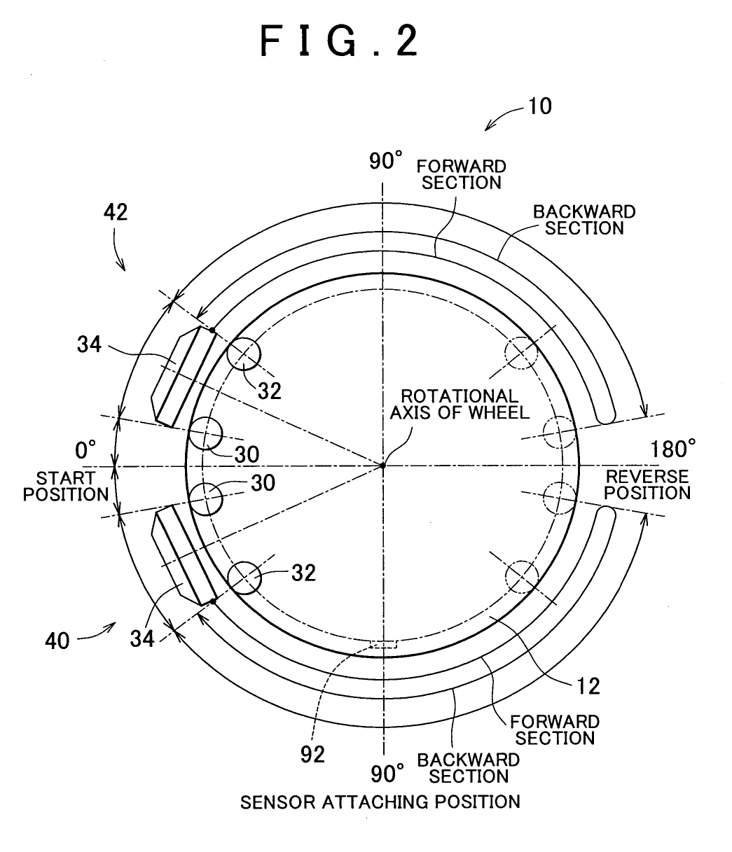

FIG. 1 is a side view showing a tire mounter 10 suitable for realizing a tire fitting method or device according to an embodiment of the invention. FIG. 2 is a plan view showing a main portion of the tire mounter 10.

As shown in FIG. 1, the tire mounter 10 includes a wheel fixture 14 on which a wheel 12 is centered, positioned and fixed while being placed horizontally. The tire mounter 10 further includes a head 20 which is operated to fit a tire 16 to the wheel 12 positioned by the wheel fixture 14.

The head 20 is designed so as to be movable up and down with respect to the wheel fixture 14 by a lifting/lowering device (not shown). The head 20 is moved to an operation position shown in FIG. 2, or a retraction position (not shown) located above the operation position. As shown in FIG. 2, the head 20 includes two roller sets 40 and 42 each of which is provided with two expansion rollers 30 and 32, and one presser roller 34.

In the embodiment, the two roller sets 40 and 42 are moved up and down together with the head 20. However, only the two roller sets 40 and 42 may be moved up and down while the head 20 is stationary.

The two roller sets 40 and 42 are turned around the axis of the wheel fixture 14 (i.e., the rotational axis of the positioned wheel 12) by a rotator (e.g., an arm) (not shown) in mutually opposite directions. The two roller sets 40 and 42 are turned around the turning axis which is the same as the axis of the wheel fixture 14.

As shown in FIG. 1, in each of the roller sets 40 and 42, each of the two expanding rollers 30 and 32 extends in parallel with the turning axis of the roller set. As shown in FIG. 2, when the expansion rollers 30 and 32 are turned, the outer surfaces of the expansion rollers 30 and 32 concentrically draw two virtual cylinders. The turning radius of each of the expansion rollers 30 and 32 is set such that the outer virtual cylinder from among the above-mentioned two virtual cylinders substantially matches a virtual cylinder contacting a rim flange portion of the wheel 12.

As shown in FIG. 1, a lower end portion of each of the expansion rollers 30 and 32 is set to be opposed to the rim flange portion of the wheel 12 with a predetermined small clearance in the axial direction of the wheel 12 while the head is at the operation position.

As shown in FIG. 1 and FIG. 2, the presser roller 34 contacts an upper side surface 50 from among paired side surfaces 50 and 52 of the tire 16 which is positioned with respect to the positioned wheel 12, and applies a force to the upper side surface 50 in a downward direction, while the head 20 is at the operation position. The presser roller 34 contacts the upper side surface 50 at the end portion. The position of the end portion is adjusted depending on a type of the tire 16 or the wheel 12 before using the tire mounter 10. This is a part of an initial adjustment, to be described later in detail.

As shown in FIG. 2, the presser roller 34 in the roller set 40 is turned around the turning axis together with the two expansion rollers 30 and 32 in the roller set 40. Also, the presser roller 34 in the roller set 42 is turned around the turning axis together with the two expansion rollers 30 and 32 in the roller set 42. As shown in FIG. 1, the presser roller 34 is a free roller rotatably attached to an end portion of an extending member 54 extending downward from the head 20. The presser roller 34 is attached to the extending member 54 so as to be rotatable with respect to the axis line extending toward the turning axis in the radial direction.

In order to fit the tire 16 to the wheel 12, the two roller sets 40 and 42 are turned one-half turn from a start position shown in FIG. 2 (a position whose turning angle around the rotational axis is “0”) in the opposite directions, and reach a reverse position (a position whose turning angle around the rotational axis is “180”). After this, each of the two roller sets 40 and 42 is turned one-half turn in the direction opposite to the preceding turning direction.

In FIG. 2, a route in which each of the roller sets 40 and 42 is moved while the corresponding roller set 40 and 42 is turned is shown by a solid line with an arrow. The route, in which each of the roller sets 40 and 42 is moved, is represented by the route in which the presser roller 34 in the corresponding roller set is moved. As seen in FIG. 2, a section from the start position to the reverse position is a forward section, and a section from the reverse position to the start position is a backward section. Each of the roller sets 40 and 42 is turned in the forward section and the backward section. In the forward section, the roller set is turned from the start position to the reverse position. In the backward section, the roller set is turned from the reverse position to the start position.

As shown in FIG. 1, the tire mounter 10 further includes a tire receiver 60. The tire receiver 60 is provided so as to adjust an actual angle of the tire 16 with respect to the wheel 12 to a target angle by holding a lower portion of the tire 16 when the tire 16 is placed on the positioned wheel 12 in a slanting direction. The height of the tire receiver 60 can be adjusted so as to adjust the position at which the tire receiver 60 contacts the tire 16. Since the position at which the tire receiver 60 contacts the tire 16 can be changed in the up-and-down direction, the actual angle of the tire 16 is changed.

The tire receiver 60 may be designed such that the tire receiver 60 itself moves in the up-and-down direction. However, in the embodiment, the tire receiver 60 is designed so as to contact the tire 16 at an inclined surface 62 which inclines with respect to the horizontal surface, and move horizontally. By using the inclined surface 62 as a surface contacting the tire 16, the horizontal movement of the tire receiver 60 is converted to the vertical movement with respect to the tire 16.

An effective height of the tire receiver 60 with respect to the tire 16 is adjusted depending on a type of the tire 16 or the wheel 12 before using the tire mounter 10. This is also a part of the initial adjustment, to be described later in detail.

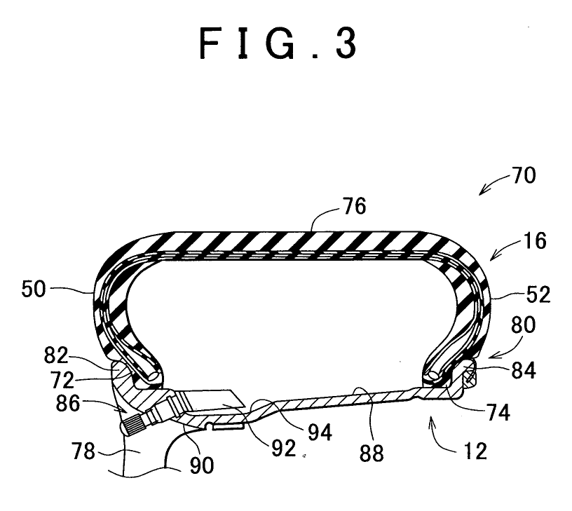

FIG. 3 is a partial cross sectional view of a tire/wheel assembly (i.e., a wheel with a tire) 70 which is constituted by fitting the tire 16 to the wheel 12 in the tire fitting method or device according to the embodiment.

In the tire 16, paired bead portions 72, and 74 are opposed to each other in the axial direction of the tire 16. The tire 16 further includes a tread portion 76.

The wheel 12 includes a disk-like hub 78 and a rim 80. In the rim 80, paired rim flange portions 82 and 84 are opposed to each other in the axial direction of the wheel 12. An outer surface 88 of the rim 80 is opposed to the tread portion 76 of the tire 16.

As shown in FIG. 3, a tire valve 86 is attached to the rim 80 at a position near the upper rim flange portion 82. The upper rim flange portion 82 is positioned above the other rim flange portion 84 when the wheel 12 is fixed to the wheel fixture 14. The tire valve 86 protrudes from a rim inner surface 90 while a base end portion of the tire valve 86 is fixed to the rim inner surface 90 at one end portion.

The base end portion of the tire valve 86 is connected to a sensor 92 which directly detects an inflation pressure in the tire 16. The sensor 92 has a communication function of wirelessly communicating with a vehicle body (not shown) to which the tire 16 is fitted.

The sensor 92 is in a shape of a flat plate with a certain thickness. A side portion of the sensor 92 is fixed to the base end portion of the tire valve 86 at one end portion. As shown in FIG. 3, in the rim outer surface 88, a convex portion 94 is formed at a position at which the tire valve 86 is attached. The sensor 92 is attached to the rim outer surface 88 using the convex portion 94.

The sensor 92 is attached to the wheel 12 before the tire 16 is fitted to the wheel 12. Therefore, the tire fitting method or device according to the embodiment is realized in order to fit the tire 16 to the rim outer surface 88 of the wheel 12, to which the sensor 92 is attached in advance.

The structure of the tire mounter 10 and the structure of the tire/wheel assembly 70 assembled using the tire mounter 10 have been described so far. Next, a method for fitting the tire 16 to the wheel 12 using the tire mounter 10 will be described in detail. First, a brief description of the tire fitting method will be made.

When the tire fitting method is performed, the tire 16 is partially fitted, from above, to the wheel 12 with the rotational axis of the tire 16 being inclined with respect to the rotational axis of the wheel 12, whereby the wheel 12 is positioned at an initial position. Then, the expansion rollers 30 and 32 together with the presser roller 34 are turned around the turning axis.

The lower bead portion 74 which is positioned below the bead portion 72 in the initial position. A lower portion 100 of the lower bead portion 74 is positioned below the upper rim flange portion 82 that is positioned above the rim flange portion 84 in the initial position, and that has already been fitted to the wheel 12. In the initial position, when the wheel 12 and the tire 16 are viewed from a direction perpendicular to the plane surface including the rotational axis of the wheel 12 and the rotational axis of the tire 16, that is, when the wheel 12 and the tire 16 are seen in a direction perpendicular to the surface of the paper on which FIG. 1 is drawn, the tire 16 is positioned with respect to the wheel 12 while the sensor 92 and a lower portion 100 do not overlap each other.

More particularly, as shown in FIG. 1, the sensor 92 is positioned below the lower portion 100 in the initial position.

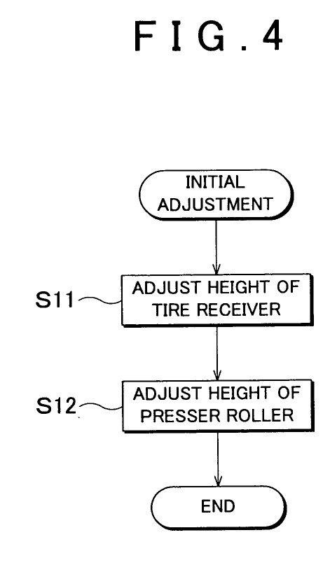

Next, the tire fitting method will be described in detail with reference to FIG. 4 to FIG. 6.

In the tire fitting method, the above-mentioned initial adjustment is performed in order to adapt the tire mounter 10 to the specifications and the types of the tire 16 and the wheel 12, before the tire 16 is fitted to the wheel 12.

FIG. 4 shows a flowchart of the initial adjustment. In the initial adjustment, in step S11, the height of the tire receiver 60 is adjusted.

The sensor 92 is positioned below the lower portion 100 of the tire 16. The height of the tire receiver is adjusted such that the actual angle of the tire 16 with respect to the horizontal surface becomes equal to a target angle, when it is estimated that the tire 16 is placed on the wheel 12 which is estimated to be positioned by the wheel fixture 14 after the initial adjustment, as shown in FIG. 1.

Next, in step S12 in FIG. 4, the height of the presser roller 34 is adjusted. More particularly, a portion of the presser roller 34, which contacts the upper side surface 50 of the tire 16 (hereinafter, simply referred to as the “position of the presser roller 34) is adjusted so as to be at a position which is deviated from a sensor pass plane where the portion passes the sensor 92 in a direction perpendicular to the rotational axis of the wheel 12.

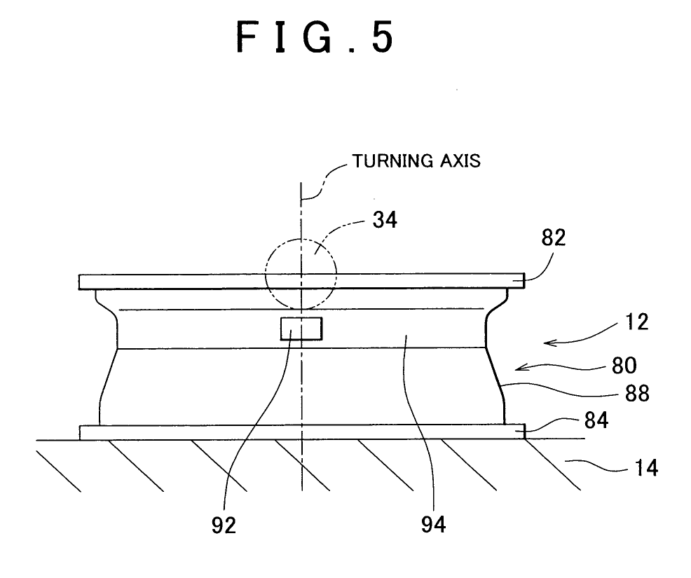

More particularly, the position of the presser roller 34 is adjusted so as to be above the sensor pass plane. Thus, as shown in FIG. 5, the presser roller 34 hardly contacts the sensor 92, or even if contacting, the presser roller 34 contacts only a fixed end of the sensor 92, when the presser roller 34 comes closest to the sensor 92 while the presser roller 34 is being turned. Therefore, when the presser roller 34 passes the sensor 92, a large bending moment due to contact with the presser roller 34 can be prevented from being generated in the sensor 92.

The initial adjustment then ends.

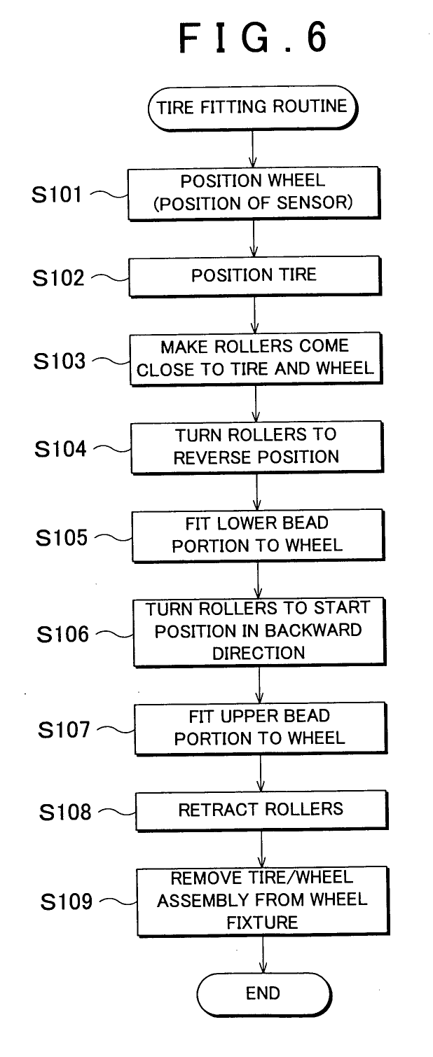

FIG. 6 shows a flowchart of a tire fitting routine in the tire fitting method. In the tire fitting routine, first, the wheel 12 is positioned by the wheel fixture 14 in step S101. At this time, as shown in FIG. 1 and FIG. 2, the wheel 12 is positioned such that the sensor 92, that is attached to the wheel 12 in advance, is at a position whose phase is deviated from the start position and the reverse position by 90 degrees, that is, a position which is apart from the start position by 90 degrees in a counterclockwise direction (or clockwise direction).

Next, in step S102 in FIG. 6, the tire 16 is positioned with respect to the wheel 12 positioned in the above-mentioned manner. As shown in FIG. 1, the tire 16 is positioned such that it is positioned the lowermost at the start position, and is supported by the tire receiver 60 at the lowermost end portion.

This position is the initial position of the tire 16. In this initial position, as shown in FIG. 1, the tire 16 is placed, from above, on the wheel 12 and is fitted to the wheel 12 only at a portion of the lower bead portion 74. This portion is the lower portion 100. A portion of the lower bead portion 74, which is above the upper flange portion 82, is an upper portion 102 that has not been fitted to the wheel in the initial state.

Next, in step S103 in FIG. 6, when the head 20 is moved downward from the retraction position to the operation position, the expansion rollers 30 and 32 and the presser roller 34 included in each of the two roller sets 40 and 42 come close to the wheel 12. The expansion rollers 30 and 32 are moved downward to a position which is opposed to the upper surface of the wheel 12 with a predetermined clearance. Meanwhile, the presser roller 34 is pressed to the upper side surface 50 of the tire 16.

Then, in step S104, the first roller set 40 is turned from the start position to the reverse position in the forward direction, that is, the counterclockwise direction in FIG. 2. Meanwhile, the second roller set 42 is turned from the start position to the reverse position in the forward direction, that is, the clockwise direction in FIG. 2, in accordance with the first roller set 40. Due to these turns, the lower bead portion 74 is fitted to the wheel 12. This process is shown as step S105 in FIG. 6.

Next, in step S106, the first roller set 40 is turned from the reverse position to the start position in the backward direction, that is, the clockwise direction in FIG. 2. Meanwhile, the second roller set 42 is turned from the reverse position to the start position in the backward direction, that is, the counterclockwise direction in FIG. 2, in accordance with the first roller set 40. Due to these turns, the upper bead portion 72 is fitted to the wheel 12. This process is shown as step S107 in FIG. 6.

The tire 16 is thus fitted to the wheel 12, whereby the tire/wheel assembly 70 is completed. After this, in step S108, the head 20 is moved upward from the operation position to the retraction position, and the two roller sets 40 and 42 are retracted from the completed tire/wheel assembly 70.

Then, in step S109, the completed tire/wheel assembly 70 is removed from the wheel fixture 14.

The tire fitting routine for the tire 16 thus ends.

As is clear from the description above, when the tire fitting method is performed, the expansion rollers 30 and 32, and the presser roller 34 start to be turned from the start position. Then, the expansion rollers 30 and 32 first contact the upper portion 102 of the lower bead portion 74, which has not been fitted to the wheel in the initial position. The position of the expansion rollers 30 and 32 when this contact starts is a contact start position.

The lower bead portion 74 is expanded in the radial direction of the tire 16 by the expansion rollers 30 and 32 at a contact position of the lower bead portion 72, at which the lower bead portion 72 contacts the expansion rollers 30 and 32. As a result, a tension is generated in the lower bead portion 74 in the circumferential direction thereof. Further, at the contact position, a portion which is a diameter of the lower bead portion 74 and which passes the contact position, is expanded. As a result, a pressing force for pressing the lower bead portion 74 to the rim outer surface 88 in the radial direction is generated.

When the expansion rollers 30 and 32 are further turned from the contact start position, a region in the tire 16, which has been fitted to the wheel 12, increases as the turning angle increases. Meanwhile, a region in the tire 16, which has not been fitted to the wheel 12, decreases. Finally, the region in the tire 16, which has not been fitted to the wheel 12, disappears, and the entire lower bead portion 74 is fitted to the wheel 12.

While the region in the tire 16, which has been fitted to the wheel 12, is increasing, each circumferential portion in the region is moved downward in the axial direction of the wheel 12 between the rim flange portions 82 and 84.

Accordingly, when the tire fitting method is performed, in an area where the expansion rollers 30 and 32 are turned from the turning start position to the above-mentioned contact start position, a tension as well as a pressing force is hardly generated in the portion of the lower bead portion 74, which is opposed to the sensor 92.

In contrast to this, in an area where the expansion rollers 30 and 32 are further turned from the contact start position, a tension is generated in the lower bead portion 74. However, the portion of the lower bead portion 72, which is opposed to the sensor 92, has already been fitted to the wheel 12, and an opposite portion with respect to the center of the wheel 12 has also been fitted to the wheel 12. Therefore, a tension is generated in the portion of the lower bead portion 74, which is opposed to the sensor 92. However, a pressing force for pressing the lower bead portion 74 to the sensor 92 is hardly generated.

In the area where the expansion rollers 30 and 32 are further turned from the contact start position, the portion of the lower bead portion 72, which is opposed to the sensor 92, is moved downward in the axial direction of the wheel 12, as the turning angle of the expansion rollers 30 and 32 increases.

The tire fitting method is performed in the aspect where the tire 16 is positioned with respect to the wheel 12 such that the sensor 92 is positioned below the lower portion 100 of the lower bead portion 74 in the initial position of the tire 16. Therefore, in the area where the expansion rollers 30 and 32 are further turned from the contact start position, the portion of the lower bead portion 74, which is opposed to the sensor 92, may contact the sensor 92 when being moved downward, unlike in the preceding area.

However, even if the lower bead portion 72 partially contacts the sensor 92, the portion of the lower bead portion 74, which is opposed to the sensor 92, has already been fitted to the wheel 12 before the contacting the sensor 92, and is not expanded in the radial direction. Accordingly, the lower bead portion 74 does not strongly press the sensor 92 when contacting the sensor 92.

In the initial position of the tire 16, the lower bead portion 74 has already been fitted to the wheel 12 at the position corresponding to the turning start position of the expansion rollers 30 and 32 from among the circumferential positions of the wheel 12. Meanwhile, at the position opposite to the start position with respect to the center of the wheel 12, that is, the position corresponding to the reverse position of the expansion rollers 30 and 32, the lower bead portion 74 has not been fitted to the wheel 12.

Accordingly, when the expansion rollers 30 and 32 are at the reverse position, and the lower bead portion 74 is attempted to be fitted to the wheel 74 at the reverse position, the lower bead portion 74 is expanded in the radial direction. As a result, a force with which the lower bead portion 74 presses the wheel 12 in the radial direction is generated. This pressing force is a force for pressing the lower bead portion 74 to the wheel 12 at each of the start position and the reverse position.

At this time, in the lower bead portion 74, a tension in the circumferential direction is generated, but a pressing force is hardly generated at the position whose phase is deviated from the start position and the reverse position by 90 degrees. In the embodiment, however, the sensor 92 is provided at the position whose phase is deviated from the start position and the reverse position by 90 degrees. Therefore, according to the embodiment, when the lower bead portion 74 is fitted to the wheel 12 at the reverse position, a large pressing force is prevented from being applied to the sensor 92.

As is clear from the description above, when the tire fitting method is performed, first, the lower bead portion 74 is fitted to the wheel 12 by turning the expansion rollers 30 and 32 and the presser roller 34 in the forward direction. Then, the upper bead portion is fitted to the wheel 12 by turning the expansion rollers 30 and 32 and the presser roller 34 in the backward direction.

When the expansion rollers 30 and 32, and the presser roller 34 are being turned in the forward direction, the lower bead portion 74 does not press the sensor 92 strongly, since the portion of the lower bead portion 74, which is opposed to the sensor 92, has already been fitted to the wheel 12.

In contrast to this, when the expansion rollers 30 and 32, and the presser roller 34 are being turned in the backward direction, the portion of the upper bead portion, which is opposed to the sensor 92, is originally positioned above the upper rim flange portion 82. Therefore, when the expansion rollers 30 and 32 and the presser roller 34 pass the portion, the upper bead portion 72 is expanded in the radial direction, crosses over the upper flange portion 82, and is fitted to the wheel 12. Therefore, the portion of the upper bead portion 72, which is opposed to the sensor 92, may press the sensor 92 strongly.

However, when the tire fitting method is performed, as mentioned above, the position of the portion of the presser roller 34, which contacts the tire 16, is at a position that is deviated from the sensor pass plane in which the portion passes the sensor 92 in a direction perpendicular to the rotational axis of the wheel 12.

Accordingly, when the presser roller 34 is turned in order to fit the upper bead portion to the wheel 12 and passes the sensor 92 during the turn, the upper bead portion 72 is prevented from strongly pressing the sensor 92 by the presser roller 34.

In the tire fitting method, the sensor 92 is attached to the wheel 12 in advance such that the fixed end of the sensor 92 is positioned near the upper rim flange portion 82 and the free end of the sensor 92 is positioned near the lower rim flange portion 84. Therefore, when the tire fitting method is performed, even if the upper bead portion 72 is pressed to the sensor 92 by the presser roller 34, the pressing is performed not at the free ends but at the fixed end of the sensor 92. Accordingly, even the same amount of pressing force is applied to the sensor 92, the bending moment generated in the sensor 92 is small.

As is clear from the description above, in the embodiment, the sensor corresponds to an example of the “accessory” in section (1), the expansion rollers 30 and 32 correspond to an example of the “expander in section (1), and step S102 corresponds to an example of the “tire positioning process” in section (1) or (2).

In addition, in the embodiment, steps S104 and S105 correspond to an example of the “lower bead portion fitting process” in section (3) or (5) in cooperation with each other. Steps S106 and S107 correspond to an example of the “upper bead portion fitting process” in section (3) or (5) in cooperation with each other. The presser roller 34 corresponds to the “presser device” in section (5).

Further, in the embodiment, step S101 corresponds to an example of the “wheel positioning process” in section (4).

Further, in the embodiment, step S12 corresponds to an example of the “presser device position adjustment process” in section (6) or (7).

While the invention has been described in detail with reference to the preferred embodiments, it will be apparent to those skilled in the art that the invention is not limited to the above-mentioned embodiments, and that the invention may be realized in various other embodiments within the scope of the invention.

1. A tire fitting method, comprising:
a process in which a wheel is positioned at an initial position by partially fitting a tire, from above, to the wheel with the rotational axis of the tire being inclined with respect to the rotational axis of the wheel, in order to fit the tire to a rim outer surface, to which an accessory is attached in advance, in the wheel having a rim in which paired rim flange portions that are opposed to each other are formed;
a process in which an expander is turned, from a state where the wheel is positioned at the initial position, around the rotational axis of the wheel, the expander partially contacting, from the side, a portion of paired bead portions of the tire, that are opposed to each other in an axial direction of the tire, the portion being to be fitted to the rim outer surface, and the expander expanding the paired bead portions in a radial direction of the wheel; and
a tire positioning process in which the tire is positioned with respect to the wheel, in a state where the accessory does not overlap a lower portion of a lower bead portion that is provided at a lower position from among the paired bead portions in the initial position, the lower portion being provided below an upper rim flange portion that is provided at an upper position from among the paired rim flange portions, and the lower portion already being fitted to the wheel, when the wheel and the tire are viewed from a direction perpendicular to a plane surface including the rotational axis of the wheel and the rotational axis of the tire in the initial position.

2. The tire fitting method according to claim 1, wherein:
the tire is positioned with respect to the wheel such that the accessory is positioned below the lower portion in the initial position, in the tire positioning process.

3. The tire fitting method according to claim 1, further comprising:
a lower bead portion fitting process in which the lower bead portion is fitted to the wheel by turning the expander one-half turn around the rotational axis of the wheel in a forward direction from a start position to a reverse position while there is an area in which the expander partially contacts the lower bead portion from the side; and
an upper bead portion fitting process in which an upper bead portion is fitted to the wheel by turning the expander one-half turn around the rotational axis of the wheel in a backward direction from the reverse position to the start position while the expander partially contacts the upper bead portion from the side, after the entire lower bead portion is fitted to the wheel.

4. The tire fitting method according to claim 3, further comprising:
a wheel positioning process in which the wheel is positioned such that the accessory is positioned at a circumferential position that is different from two positions corresponding to the start position and the reverse position, respectively, from among circumferential positions of the wheel, before the tire positioning process is performed.

5. The tire fitting method according to claim 3, wherein:
the lower bead portion fitting process is a process in which the expander and a presser device, that partially contacts an upper side surface provided at an upper position from among paired side surfaces of the tire and that presses the tire in the axial direction of the wheel, are turned one-half turn around the rotational axis of the wheel in the forward direction from the start position to the reverse position while the expander partially contacts the lower bead portion from the side; and
the upper bead portion fitting process is a process in which the expander and the presser device are turned one-half turn around the rotational axis of the wheel in the backward direction from the reverse position to the start position while the expander partially contacts the upper bead portion from the side, after the entire lower bead portion is fitted to the wheel.

6. The tire fitting method according to claim 5, further comprising:
a presser device position adjustment process in which a position of a portion of the presser device, which contacts the tire, is adjusted so as to be at a position that is deviated from an accessory pass plane where the portion passes the accessory in a direction perpendicular to the rotational axis of the wheel.

7. The tire fitting method according to claim 6, wherein
the position of the portion of the presser device, which contacts the tire, is adjusted so as to be a position above the accessory pass plane in the pressing device position adjustment process.

8. A tire fitting device, comprising:
a wheel fixture on which a wheel is positioned and fixed;
a head which is movable up and down with respect to the wheel fixture, and which fits a tire to the wheel positioned by the wheel fixture; and
an expander which is provided in the head and which expands the tire in a radial direction of the wheel, wherein
the wheel is positioned at an initial position by partially fitting the tire, from above, to the wheel with the rotational axis of the tire being inclined with respect to the rotational axis of the wheel, in order to fit the tire to a rim outer surface, to which an accessory is attached in advance, in the wheel having a rim in which paired rim flange portions that are opposed to each other are formed;
the expander is turned, from a state where the wheel is positioned at the initial position, around the rotational axis of the wheel, the expander partially contacting, from the side, a portion of paired bead portions of the tire, that are opposed to each other in an axial direction of the tire, the portion being to be fitted to the rim outer surface, and the expander expanding the paired bead portions in the radial direction of the wheel; and
the tire is positioned with respect to the wheel, in a state where the accessory does not overlap a lower portion of a lower bead portion that is provided at a lower position from among the paired bead portions in the initial position, the lower portion being provided below an upper rim flange portion that is provided at an upper position from among the paired rim flange portions, and the lower portion already being fitted to the wheel, when the wheel and the tire are viewed from a direction perpendicular to a plane surface including the rotational axis of the wheel and the rotational axis of the tire in the initial position.

9. The tire fitting device according to claim 8, wherein
when the tire is positioned, the tire is positioned with respect to the wheel such that the accessory is positioned below the lower portion in the initial position.

10. The tire fitting device according to claim 8, wherein
the lower bead portion is fitted to the wheel by turning the expander one-half turn around the rotational axis of the wheel in a forward direction from a start position to a reverse position while there is an area in which the expander partially contacts the lower bead portion from the side; and
the upper bead portion is fitted to the wheel by turning the expander one-half turn around the rotational axis of the wheel in a backward direction from the reverse position to the start position while the expander partially contacts the upper bead portion from the side, after the entire lower bead portion is fitted to the wheel.

11. The tire fitting device according to claim 10, wherein
the wheel is positioned such that the accessory is positioned at a circumferential position which is different from two positions corresponding to the start position and the reverse position, respectively, from among circumferential positions of the wheel, before the tire is positioned.

12. The tire fitting device according to claim 11, further comprising:
a presser device which is provided in the head, wherein
when the lower bead portion is fitted to the wheel, the expander and the presser device, that partially contacts an upper side surface provided at an upper position from among paired side surfaces of the tire and that presses the tire in the axial direction of the wheel, are turned one-half turn around the rotational axis of the wheel in the forward direction from the start position to the reverse position while the expander partially contacts the lower bead portion from the side; and
when the upper bead portion is fitted to the wheel, the expander and the presser device are turned one-half turn around the rotational axis of the wheel in the backward direction from the reverse position to the start position while the expander partially contacts the upper bead portion from the side, after the entire lower bead portion is fitted to the wheel.

13. The tire fitting device according to claim 12, wherein
a position of a portion of the presser device, which contacts the tire, is adjusted so as to be at a position which is deviated from an accessory pass plane where the portion passes the accessory in a direction perpendicular to the rotational axis of the wheel.

14. The tire fitting device according to claim 13, wherein
when the position of the presser device is adjusted, the position of the portion of the presser device, which contacts the tire, is adjusted so as to be above the accessory pass plane.
